(19) United States
(12) Patent Application Publication
(10) Pub. No.: US 2026/0109033 A1
(43) Pub. Date: Apr. 23, 2026

(54) SYSTEM AND METHOD FOR ORCHESTRATING ROBOTIC ARMS TO MANAGE ITEM-SHIFTING

(71) Applicant: PES University, Bengaluru (IN)

(72) Inventors: Suresh Narasimha, Karnataka (IN); Rakshith B S, Bangalore (IN); Akshay K B, Bangalore (IN); Kiriti Kapavari, Bangalore (IN)

(21) Appl. No.: 19/001,607

(22) Filed: Dec. 26, 2024

(30) Foreign Application Priority Data
Oct. 22, 2024 (IN) 202441080090

(51) Int. Cl. B25J 9/16; B25J 13/08

(52) U.S. Cl. CPC B25J 9/1661; B25J 9/163; B25J 9/1682; B25J 13/08

(57) ABSTRACT

Embodiments of the present disclosure are directed to a system and method (together termed as mechanism) for orchestrating robotic arms to manage item-shifting. The mechanism includes receiving item list from a user for item shifting using robotic arms. The item list includes items selected from a plurality of available items. Further, the mechanism includes capturing positional data associated with item shifting. Furthermore, the mechanism includes detecting features and attributes of the selected items to be shifted. Moreover, the mechanism includes determining a shifting order for the selected items to be shifted. In an embodiment, the mechanism includes activating the two or more robotic arms for shifting the selected items to be shifted. Further, the mechanism includes collecting real-time movement data of each of the activated robotic arms. Furthermore, the mechanism includes orchestrating the movements of the identified two or more robotic arms.

### BACKGROUND

### Cross-Reference to Related Application

This application is based upon and claims priority from, Application No. IN 202441080090, filed on 22 Oct. 2024 the entireties which are incorporated herein by reference for all purposes.

### TECHNICAL FIELD

The present disclosure relates to the field of industrial automation systems, and in particular, relates to a system and method for orchestrating the two or more robotic arms to efficiently and accurately shift items within a designated environment.

### DESCRIPTION OF THE RELATED ART

In today's rapidly evolving industrial and logistics sectors, the demand for efficient and precise item handling has reached unprecedented levels. As global commerce and supply chains continue to expand, the pressure on facilities to increase throughput while maintaining accuracy has intensified. This environment necessitates a high level of operational precision, as even minor inefficiencies or errors in item handling can lead to significant repercussions, including delays in production lines or disruptions in the supply chain. While robotic arms have become critical tools in these operations, the need for coordinating multiple robotic arms to manage these tasks has introduced additional complexities. Optimizing the orchestration of two or more robotic arms to enhance item movement and management processes has become essential for industries aiming to meet these growing demands.

Many industrial settings deploy multiple robotic arms or automated machinery to handle tasks simultaneously. However, the precise coordination of these robotic arms presents a significant challenge. Ensuring synchronization between the two or more robotic arms is crucial to avoid collisions, maintain smooth operations, and maximize efficiency. Despite their advanced capabilities, robotic arms often face difficulties in achieving the necessary level of coordination, leading to delays, reduced throughput, or even damage to items or equipment. The complexity of orchestrating two or more robotic arms is further amplified by the diverse range of items that need to be managed. Items vary widely in size, shape, weight, and material, each presenting unique challenges in terms of how they are handled, moved, and placed. Current robotic systems are not always adaptable enough to manage this variability effectively, which can result in improper handling and positioning of items.

Additionally, the dynamic nature of industrial and logistics environments adds another layer of complexity to the operation of two or more robotic arms. Items are rarely static; their locations can change frequently due to factors such as prior handling steps, environmental conditions, or ongoing operations. This constant movement presents significant challenges to the robotic arms, which must adapt swiftly to changes in item location while ensuring accurate identification and management. However, the ability of robotic arms to track and adjust to these changes is often inadequate, leading to disruptions in the operational flow and the potential for bottlenecks.

Moreover, the high-speed nature of modern industrial processes leaves little room for error. Any mistake in handling, whether due to the misidentification of an item or incorrect placement by one of the robotic arms, can cause significant disruptions. These disruptions not only affect the immediate process but can also cascade through the entire operation, leading to greater inefficiencies and potential losses. Despite their technological advancements, robotic arms frequently struggle to maintain the necessary accuracy under these conditions, especially when multiple arms are involved, emphasizing the critical need for improvements in their coordination and integration into the overall handling process.

Given these challenges, the speed and efficiency of item handling by two or more robotic arms are pivotal to user satisfaction. Users expect prompt and accurate processing when they provide a list of items for selection and picking. However, the current limitations of robotic arms in managing these tasks can result in delays, causing frustration, particularly if these delays impact delivery schedules or disrupt planned operations.

Thus, there is a need for an improved system and method for orchestrating two or more robotic arms in item handling, to overcome the above drawbacks.

### BRIEF SUMMARY

One or more embodiments of the present disclosure are directed to a system and method for orchestrating robotic arms to manage item-shifting

An embodiment of the present disclosure relates to a system for orchestrating two or more robotic arms to manage item shifting. The system includes a receiver to receive, via a communication device, an item list from a user. The item list includes one or more items selected, from a plurality of available, items, for item using two or more robotic arms. The two or more robotic arms are of a mounting type. Further, the two or more robotic arms include an end actuator on each of the two or more robotic arms for shifting one or more items. The end actuator on each robotic arm includes a gripper or a suction mechanism for item shifting. In an embodiment, the item shifting includes picking the selected one or more items and/or dropping the selected one or more items.

In an embodiment, the system includes a mapping module to capture positional data associated with layout of a shifting location, position of the selected one or more items to be shifted, and/or location of each of the two or more robotic arms. The shifting location includes a pick-up location or a drop-off location.

In an embodiment, the system includes a detection module to detect features and attributes of the selected one or more items to be shifted. The detected features and attributes of the one or more items include identification, size, shape, and softness of the selected one or more items. In an embodiment, the capturing positional data features, detecting features and attributes, and determination of plurality of available items is performed by one or more sensors. The one or more sensors include visual capturing sensor, product identification code recognition sensor, RGB cameras, lidar, and stereo vision cameras.

In an embodiment, the system includes a centralized control unit configured to determine a shifting order for the selected one or more items to be shifted, based on the captured layout of the shifting location, the captured position of the one or more items to be shifted, the captured position of the two or more robotic arms, and/or the detected features and attributes of the selected one or more items to be shifted. In an embodiment, the centralized control unit is configured to activate the two or more robotic arms for shifting the selected one or more items to be shifted, based on the shifting order, and/or power consumption of each of the two or more robotic arms. Further, the centralized control unit is configured to collect real-time movement data of each of the activated two or more robotic arms. Furthermore, the centralized control unit is configured to orchestrate the movements of the identified two or more robotic arms based on the shifting order, the activated two or more robotic arms, and/or the collected real-time movement data. Moreover, the centralized control unit is configured to obtain user approval to orchestrate the movements of the identified two or more robotic arms.

In an embodiment, the system includes a renderer to render a simulation depicting the shifting order, the identified two or more robotic arms, and an estimated time required to shift the one or more items from the item list.

An embodiment of the present disclosure discloses a method for orchestrating robotic arms to manage item shifting. The method includes receiving, via a communication device, an item list from a user. The item list includes one or more items selected, from a plurality of available items, for item shifting using two or more robotic arms. Further, the method includes capturing positional data associated with layout of a shifting location, position of the selected one or more items to be shifted, and location of each of the two or more robotic arms. Furthermore, the method includes detecting features and attributes of the selected one or more items to be shifted. Moreover, the method includes determining a shifting order for the selected one or more items to be shifted, based on the captured layout of the shifting location, the captured position of the one or more items to be shifted, the captured position of the two or more robotic arms, and the detected features and attributes of the selected one or more items to be shifted. Additionally, the method includes activating the two or more robotic arms for shifting the selected one or more items to be shifted, based on the shifting order, and power consumption of each of the two or more robotic arms.

In an embodiment, the method includes collecting real-time movement data of each of the activated two or more robotic arms. Further, the method includes orchestrating the movements of the identified two or more robotic arms based on the shifting order, the activated two or more robotic arms, and the collected real-time movement data.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an environment having an orchestration system for orchestrating two or more robotic arms to manage item-shifting, in accordance with an embodiment of the present disclosure;

FIG. 2 illustrates a block diagram of the orchestration system for orchestrating two or more robotic arms to manage item-shifting, in accordance with an embodiment of the present disclosure;

FIG. 3A-3B illustrates exemplary interfaces facilitating the selection of items from a plurality of available items 114, in accordance with an embodiment of the present disclosure;

FIG. 3C illustrates an exemplary interface to provide simulation and receive user approval, in accordance with an embodiment of the present disclosure;

FIG. 4 illustrates an operation 400 for orchestrating two or more robotic arms 110 to manage item-shifting, in accordance with an embodiment of the present disclosure;

FIG. 5 illustrates a flowchart of a method for orchestrating two or more robotic arms to manage item-shifting, in accordance with an embodiment of the present disclosure; and

FIG. 6 illustrates an exemplary computer system in which or with which embodiment of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a system and method (together termed as mechanism) for orchestrating two or more robotic arms to manage item shifting. The mechanism includes receiving an item list from a user via a communication device. The item list includes one or more items selected from a plurality of available items. In some embodiments, the mechanism includes determining positional data for the item shifting, such as the layout of the shifting location, the position of the selected one or more items to be shifted, and the location of each of the two or more robotic arms. In some embodiments, the mechanism includes detecting features and attributes of the selected items, such as size, weight, and shape, to ensure appropriate handling. In some embodiments, the mechanism includes a centralized control unit to determine the optimal shifting order for the items, based on the captured positional data and detected attributes. The mechanism includes activating the two or more robotic arms to carry out the shifting process. In some instances, the mechanism collects real-time movement data of the robotic arms, allowing it to orchestrate precise and efficient movements based on the shifting order, power consumption, and real-time data.

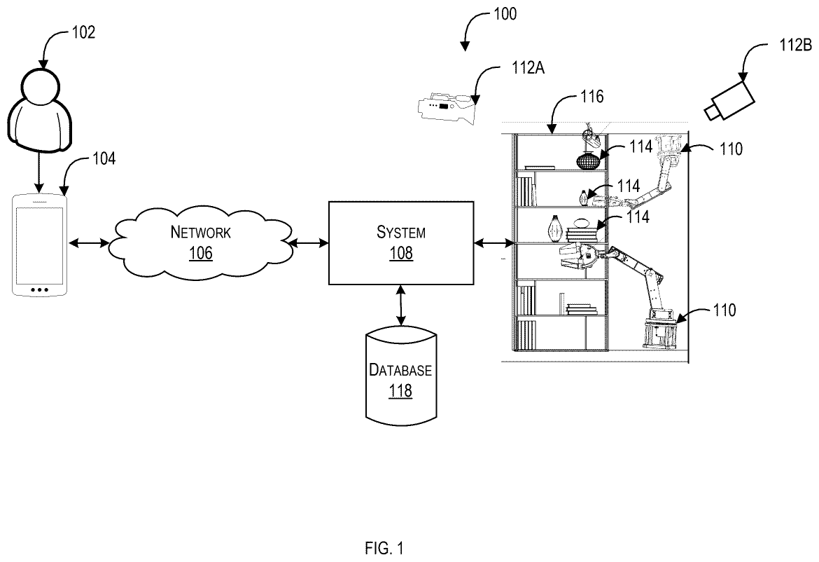

FIG. 1 illustrates an environment 100 having an orchestration system 108 for orchestrating two or more robotic arms 110 to manage item shifting, in accordance with an embodiment of the present disclosure. In an embodiment, the environment 100 may include a user 102, a user device 104, a communication network 106, the orchestration system 108, the two or more robotic arms 110, one or more sensors 112A, 112B . . . 112N (hereforth also known as sensors 112), plurality of available items 114, a shifting location 116, a database 118.

In an embodiment, the environment 100 may include a retail store where efficiency, precision, and handling complexity are crucial. The simultaneous operation of two or more robotic arms 110 in such environment 100 may allow for faster and more coordinated item retrieval. Such operations may ensure that multiple items are handled at once, reducing the time spent on collecting and processing the user 102 selected products. In one embodiment, the environment 100 may be an automated warehouse, manufacturing plant, or distribution center where large volumes of items need to be moved, sorted, or arranged efficiently. In such environment 100, precision and coordination are essential, particularly when handling various types of items with differing characteristics, such as size, weight, and fragility. The two or more robotic arms 110 may collaborate to address these challenges and enhance overall operational efficiency.

In an embodiment, the environment 100 may be a sorting center or a fulfillment warehouse where speed and efficiency are paramount. The two or more robotic arms 110 may operate in parallel to pick, move, or sort several items simultaneously. The simultaneous operation may reduce the overall time required to complete tasks, as each arm of the two or more robotic arms 110 may work on separate items or different parts of a larger task. For instance, one arm may pick an item from a storage bin, while another arm places an item onto a conveyor belt for further processing, all occurring simultaneously.

In an embodiment, a single robotic arm may not be sufficient to handle large or heavy item safely or efficiently. In such cases, two or more robotic arms 110 may work together to lift and move the item in a balanced manner, reducing the strain on any individual arm and minimizing the risk of damaging the item or the surrounding area. The coordinated effort of the two or more robotic arms 110 may allow for the safe transport of bulky or awkwardly shaped objects that require multiple points of support during handling. In an embodiment, when dealing with fragile or delicate items, the two or more robotic arms 110 may work in coordination to carefully handle and transport these objects without causing damage. The two or more robotic arms may distribute the load across multiple points of contact, ensuring that delicate items, such as glassware or electronics, are not subjected to excessive pressure or jolts. Further, the two or more robotic arms 110 may also adjust their grip and movement to match the specific requirements of each item, offering a level of care and precision that is difficult to achieve with human handling.

In an embodiment, the user 102 may be an operator in a warehouse, a retail employee managing inventory, or even an individual shopper seeking to select one or more items from a shelf or rack. Further, the user 102 may select one or more items from a plurality of available items 114 from the shifting location 116 using the user device 104. The plurality of available item 114 may vary in size, shape, and material, and are selected from a plurality of available items 114.

In one embodiment, the network 106 may be a wireless network such as Bluetooth, Wireless Fidelity (Wi-Fi), Global System for Mobile Communication (GSM), ZigBee, and Infrared (IR) network. In another embodiment, the network 106 may include a wired network connection, such as wire based Local Area Network (LAN).

The user device 104 may be, but is not limited to, a smartphone, a Personal Assistant Device (PDA), a PC, a tablet, a laptop, a smartwatch, a VR-AR device, and so on. The user device 104 may be any equipment that provisions the user 102 to interact with the orchestration system 108. The interface may include but is not limited to, a display screen, a microphone, a speaker, a camera, and so on.

In an embodiment, the sensors 112 may be part of the two or more robotic arms 110, such as integrated robotic cameras. In an embodiment, the sensors 112 may be positioned separately from the two or more robotic arms. In an embodiment, the sensors 112 may be mounted on a separate structure within the shifting location 116, providing a fixed viewpoint to monitor the entire area. In an embodiment, the sensors 112 may communicate with each other and with the system 108, via the network 106, allowing for the seamless integration of data from multiple sensors. The system 108 synthesizes information from various viewpoints, resulting in a more accurate and holistic understanding of the shifting location 116.

In an embodiment, the one or more sensors 112 may determine the availability of plurality of available items 114, layout of a shifting location 116, position of the selected one or more items to be shifted, and/or location of each of the two or more robotic arms 110 (here forth also known as robotic arms 110). The sensors 112 may continuously monitor the shifting location 116 to detect any changes in the availability of the items 114. Further, the sensors 112 may map out the entire layout of the shifting location 116, capturing details such as the arrangement of storage racks, aisles, and pathways, which are critical for efficient item shifting. Furthermore, the sensors 112 may identify the position of the selected one or more items, within the shifting location 116, to be shifted. Moreover, the sensors 112 may determine features and attributes of the selected one or more items to be shifted. The features and attributes of the selected one or more items may include size, shape, and surface characteristics, which are essential for effective item handling and shifting operations.

In an embodiment, the sensors 112 may identify various mounting positions of the robotic arms 110, including side-mounted, bottom-mounted, and roof-mounted configurations. The side-mounted robotic arms 110 may be positioned along the walls or sides of the shifting location 116, allowing them to extend horizontally to reach items. The bottom-mounted robotic arms 110, on the other hand, may be positioned on the floor or beneath storage racks, enabling vertical movements to lift and place items. The roof-mounted robotic arms 110 may be suspended from the ceiling or overhead structures, offering a wide range of motion to access items from above.

In an embodiment, the two or more robotic arms 110 may be equipped with various types of grips, each designed to handle specific items with precision and care. The grips may range from soft, cushioned grippers for handling delicate or fragile items to more robust, firm grips for managing heavier or bulkier objects. The versatility in grip types ensures that the system 108 can effectively accommodate a wide range of items, applying the appropriate amount of force and securing each item properly during the shifting process. In an embodiment, the two or more robotic arms 110 may be equipped suction mechanism for shifting the selected item.

In an embodiment, the user device 104 may facilitate the user 102 to communicate with the orchestration system 108, via the network 106, to manage item shifting of the selected one or more items. The item shifting may include picking the selected one or more items and/or dropping the selected one or more items. In an embodiment, the orchestration system 108 may orchestrate the robotic arms 110 to shift the selected one or more items from the shifting location 116. In an embodiment, the two or more robotic arms 110 may be equipped to perform tasks such as picking up, transporting, and dropping items.

In an embodiment, the shifting location 116 may be a pick-up location from where the requested are to be shifted. For example, in a retail setting, the shifting location 116 may be a shelving unit where available items are stored and displayed for shoppers to select one or more items. In an industrial or warehouse setting, the shifting location 116 may be part of a storage unit designed to hold a large volume of items, with features that facilitate organized storage and efficient retrieval. In an embodiment, the shifting location 116 may be a destination where the selected one or more items are dropped off. The selected one or more items may be retrieved from a different location or processing step and placed in the shifting location 116 for further management or distribution. In a retail environment, the shifting location 116 may include replenishing a storage unit with new stock. In an industrial environment, the item shifting may include organizing items into specific storage areas for inventory management or preparing them for shipping.

In an embodiment, the database 118 may store information essential for orchestrating item shifting with robotic arms 110. The database 118 may include details about each item available for shifting, such as identification codes, descriptions, dimensions, and weight. Further, the database 118 may store data on shifting locations, covering aspects like storage units, pick-up points, drop-off locations, and spatial arrangement. Furthermore, the database 118 may track specifications and statuses, including locations, operational conditions, and maintenance records of the robotic arms 110. Moreover, the database 118 may store user profiles, access levels, and historical interactions are recorded to manage requests effectively.

In an embodiment, the database 118 may store records of shifting orders, including the items involved and the item shifting sequences, along with timestamps of actions. The database may store sensor data captured by one or more sensors 112, identification code readers, and environmental monitors are included.

In an embodiment, the user 102 may interact with the user device 104 to select one or more items from the plurality of available items 114 within the shifting location 116. The orchestration system 108 via the network 106 may orchestrate the two or more robotic arms 110 to shift the one or more selected items from the shifting location 116. Further, the orchestration system 108 may utilize data from the sensors 112 and/or database 118 to identify the precise position of the selected items within the shifting location 116 and determine the most efficient path for the robotic arms 110. Furthermore, the orchestration system 108 may access relevant data stored in the database 118, such as the size, shape, and handling requirements of the selected items. Based on the data captured by the sensors 112 and/or data stored in the database, the orchestration system 108 may assign the appropriate robotic arms 110 to handle and transport the selected items. The robotic arms 110 may then be guided to carefully pick up the selected items, navigate through the shifting location 116, and shift the items to the designated drop-off or storage area. In an embodiment, the orchestration system 108 may also simulate the process, on the user device 104, to allow for user input or approval before executing the movements.

In an embodiment, the user may select only one item from the plurality of available items 114 within the shifting location 116. In such scenario, the system may orchestrate one robotic arm to shift the item. In an embodiment, the selected one item may be heavy. In such scenario, the system may orchestrate the two or more robotic arms 110 to shift the heavy item.

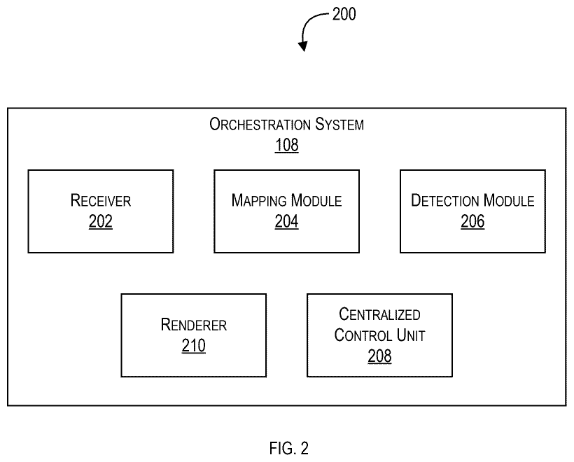

FIG. 2 illustrates a block diagram 200 of the orchestration system 108 for orchestrating robotic arms 110 to manage item-shifting, in accordance with an embodiment of the present disclosure. In an embodiment of the present disclosure, the orchestration system 108 (herewith also known as system 108) may include a receiver 202, a mapping module 204, a detection module 206, a centralized control unit 208, and a renderer 210. The receiver 202, the mapping module 204, the detection module 206, the centralized control unit 208, and the renderer 210 may be communicatively coupled to a memory and a processor of the orchestration system 108. The processor may control the operations of the mapping module 204, the detection module 206, the centralized control unit 208, and the renderer 210. In an embodiment of the present disclosure, the processor and the memory may form a part of a chipset installed in the orchestration system 108. In another embodiment of the present disclosure, the memory may be implemented as a static memory or a dynamic memory. For an example, the memory may be internal to the orchestration system 108, such as an onside-based storage. In another example, the memory may be external to the orchestration system 108, such as cloud-based storage. Further, the processor may be implemented as one or more microprocessors, microcomputers, digital signal processors, central processing units, state machines, logic circuitries, and/or any devices that manipulate signals based on operational instructions.

In an embodiment, the receiver 202 may receive, via a communication device, an item list from the user 102. The item list may include one or more items selected, from a plurality of available items, for item shifting using two or more robotic arms 110. The user input may vary widely depending on the specific application and environment in which the system 108 is deployed. For instance, in a warehouse setting, the user 102 may input a command to retrieve a specific item from a designated shifting location 116, or in a retail environment, a customer might select an item for purchase through an interface connected to the system 108. The receiver 202 may handle various forms of user input such as text, voice, image, video inputs, or even pre-programmed instructions entered via a connected device. The user input data received may include specific details such as the identification of the item to be shifted, the destination where the item needs to be moved, or any special handling instructions required due to the item's characteristics.

In an embodiment, the mapping module 204 may capture positional data related to the item-shifting process within the operational environment. The positional data captured may include layout of a shifting location, position of the selected one or more items to be shifted, and location of each of the two or more robotic arms. The layout of the shifting location may be the dimensions and arrangement of the area where the selected one or more items are stored or need to be relocated. The position of the selected one or more items to be shifted includes identifying the location of each of the selected one or more items within the storage unit, ensuring that the two or more robotic arms 110 may efficiently locate and retrieve the items. In a dynamic environment setting, such as in warehouses, where the layout or item positions may change frequently the mapping module 204 may continuously update the positional data to reflect the current state of the environment.

In an embodiment, the mapping module 204 may track the positions of the two or more robotic arms 110. The precise location and orientation of each robotic arm 110 may assist in preventing potential collisions and optimize the movements of the arms for efficiency and safety. In an embodiment, the mapping module 204 may capture additional environmental factors, such as obstacles or other machinery within the operational area, and integrate the information into the positional data. In an embodiment, the mapping module 204 may provide real-time and accurate positional data for seamless integration and coordination of the robotic arms within the overall item-shifting process, ensuring that each movement is optimized for speed, accuracy, and safety.

In an embodiment, the detection module 206 may detect features and attributes of the selected one or more items to be shifted. The detected features and attributes of the one or more items include identification, size, shape, and softness of the selected one or more items. The detection of features and attributes of the one or more items is performed using one or more sensors 112. The one or more sensors 112 include a visual capturing sensor, product identification code recognition sensor, RGB cameras, lidar (Light Detection and Ranging), and stereo vision cameras. The visual capturing sensors may provide real-time images of the items, and product identification code recognition sensors may scan barcodes or QR codes to confirm the identity of each item. The RGB cameras may capture color images to further assist in item recognition and assessment. The lidar sensors may measure the distance between the item and the sensors, creating a 3D model of the item's shape and size. The stereo-vision cameras may provide depth perception, enabling the system 108 to understand the item's spatial orientation.

In an embodiment, the detection module 206 using the one or more sensors 112 may build a profile of each item to determine the best method for handling and shifting the item. For instance, in a warehouse environment, the detection module 206 may identify a large, heavy box and calculate the appropriate force required by the robotic arms 110 to lift and move the box without causing damage. Similarly, when a fragile item is detected, the system 108 may adjust the end actuator grip strength to ensure careful handling. The accurate detection and analysis of the features and attributes of the one or more items is crucial for optimizing the efficiency and safety of the item-shifting process within various industrial and logistics settings.

In an embodiment, the centralized control unit 208 may determine a shifting order for the selected one or more items to be shifted based on the captured layout of the shifting location, the captured position of the one or more items to be shifted, the captured position of the two or more robotic arms, and/or the detected features and attributes of the selected one or more items to be shifted. The centralized control unit 208 may activate the two or more robotic arms 110 for shifting the selected one or more items to be shifted, based on the shifting order, and power consumption of each of the two or more robotic arms 110. Further, the centralized control unit 208 may collect real-time movement data of each of the activated two or more robotic arms 110. Furthermore, the centralized control unit 208 may orchestrate the movements of the identified two or more robotic arms 110 based on the shifting order, the activated two or more robotic arms 110, and the collected real-time movement data. In an embodiment, the centralized control unit 208 may obtain user approval to orchestrate the movements of the identified two or more robotic arms 110.

In an embodiment, the centralized control unit 208 may determine a shifting order for the selected one or more items based on the captured layout of the shifting location, including the spatial arrangement and accessibility of the areas where items need to be picked up or dropped off. The centralized control unit 208 integrates the layout information with the captured positions of the items to be shifted, ensuring that each item is moved in a sequence that optimizes efficiency and minimizes travel distance. In an embodiment, the centralized control unit 208 may consider the positions of the robotic arms 110 to plan movements that avoid collisions and ensure that each arm is utilized effectively. In an embodiment, the centralized control unit 208 may adjust the shifting order based on the detected features and attributes of the items, such as the size, shape, and fragility, to accommodate specific handling requirements. For example, if a fragile item is detected, the control unit may prioritize its movement to prevent unnecessary handling or delays.

In an embodiment, based on the shifting order the centralized control unit 208 may proceed to activate the robotic arms 110. The centralized control unit 208 may send commands to initiate the movements of the robotic arms 110 according to the predetermined order. Further, the centralized control unit 208 may monitor the power consumption of each of the robotic arms 110 to ensure that no arm is overburdened or underutilized, thereby balancing the load across all available arms and preventing potential failures or inefficiencies. Furthermore, the centralized control unit 208 may continuously collect real-time movement data from each activated robotic arm 110. The collected data may include information on the robotic arms 110 positions, speeds, and operational status. By analyzing this real-time feedback, the centralized control unit 208 may detect deviations from the planned movements, such as unexpected obstacles or delays, and make necessary adjustments to maintain the smooth execution of the item-shifting process.

In an embodiment, the centralized control unit 208 may orchestrate the movements of the robotic arms 110 based on the shifting order, the status of the activated arms, and the real-time movement data. The orchestration may include synchronizing the actions of two or more robotic arms 110 to ensure coordinated and precise execution of the shifting tasks. The centralized control unit 208 may manage the timing and sequencing of each of the two or more robotic arm 110 movements to avoid interference and optimize the overall workflow.

In an embodiment, the centralized control unit 208 may seek user approval for the proposed movements before proceeding, ensuring that the planned actions align with user expectations and operational requirements.

In an embodiment, the renderer 210 may render a simulation depicting the shifting order, the identified two or more robotic arms 110, and an estimated time required to shift the one or more items from the item list. The renderer 210 may generate and visualize a detailed simulation that visually represents the entire item-shifting process. The visualization may include real-time animations of the robotic arms, highlighting identified roles and movements during the operation, for the users to see how each of the two or more robotic arms 110 may engage with specific items, including how the two or more robotic arms 110 may coordinate their movements to execute the shifting task efficiently.

In an embodiment, the simulation may also provide an estimated time required to complete the entire item-shifting process. The time estimation may be based on various factors, including the distance between items and the shifting location 116 the speed and efficiency of the robotic arms 110, and any detected features of the items that might affect handling time, such as fragility or weight. By providing the time estimate, the renderer 210 may allow the user 102 to anticipate how long the operation will take, aiding in scheduling and resource planning.

In an embodiment, the user 102 may review and, if necessary, modify the shifting order or the movements of the robotic arms 110. For example, if a user 102 identifies a potential issue in the proposed sequence, such as the handling of a particularly delicate item, they may be able to adjust the shifting order or instruct the system 108 to use a different arm configuration. The renderer 210 may also allow the user 102 to simulate different scenarios, such as varying the speed of the arms or changing the layout of the shifting location 116, to see how these changes might impact the operation.

In an embodiment, the simulation may include detailed visualizations of the environment, showing the layout of the shifting location 116, the positions of items, and the placement of the robotic arms 110. The simulation allows the user 102 to understand how the system 108 may interact with the physical environment and identify any potential obstacles or inefficiencies before the operation begins. The renderer 210 may also highlight critical moments in the shifting process, such as when two or more robotic arms 110 coordinate closely to move a large or awkwardly shaped item.

In an embodiment, the system 108 may execute the shifting process in sequence, where each robotic arm of the two or more robotic arms 110 may operate one after the other to pick up and drop the selected items. The sequential approach may be beneficial in scenarios where precise timing and careful coordination are required, such as when handling fragile items that cannot be moved simultaneously.

In another embodiment, the two or more robotic arms 110 may be orchestrated to work simultaneously, with each arm carefully picking and dropping items at the same time. The parallel operation may increase the overall speed of the shifting process, making the system 108 ideal for environments where time efficiency is critical, such as in high-volume warehouses or distribution centers.

In an embodiment, the system 108 may dynamically adjust between sequential and simultaneous operations based on the size, weight, and fragility of the selected items. For example, heavier or more delicate items may be shifted one at a time, while lighter, more robust items are handled in parallel by two or more robotic arms 110.

In another embodiment, the system 108 may allow the user 102 to customize the shifting process through the user interface, providing options to select whether the two or more robotic arms 110 operate sequentially or simultaneously, depending on the user's priorities, such as speed, safety, or precision.

In yet another embodiment, the system 108 may include a learning module that observes past item shifts and adapts the orchestration of the two or more robotic arms 110 over time, optimizing for efficiency by deciding when to operate sequentially or simultaneously based on historical data related to item handling and operational outcomes.

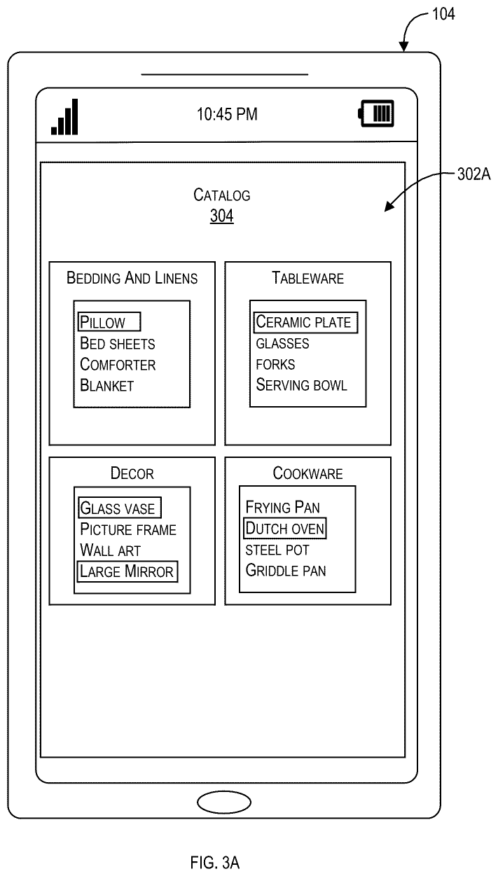

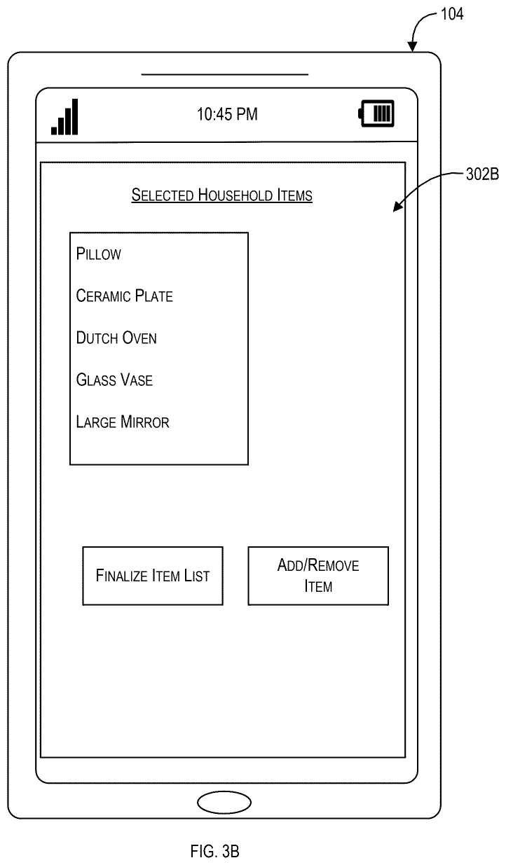

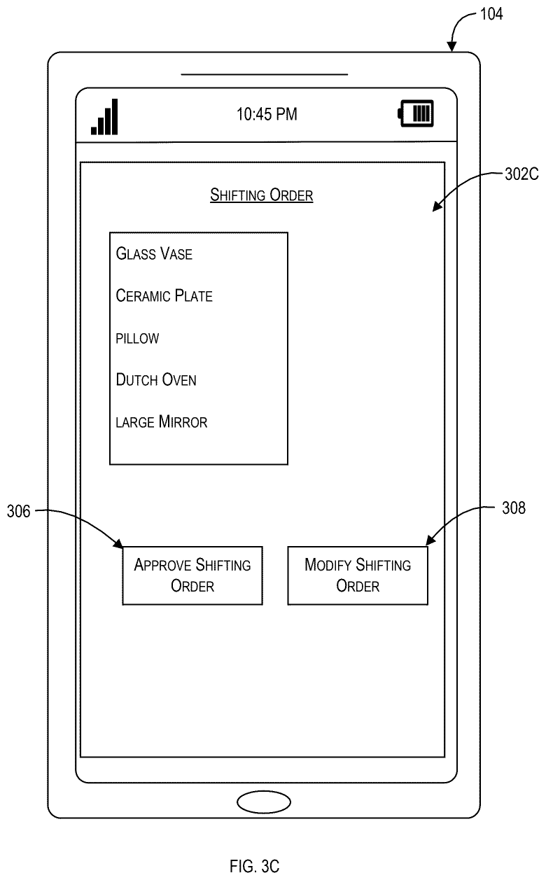

FIG. 3A-3B illustrates exemplary interfaces 302A and 302B facilitating the selection of items from a plurality of available items 114, in accordance with an embodiment of the present disclosure. FIG. 3C illustrates an exemplary interface 304C to provide simulation and receive user approval, in accordance with an embodiment of the present disclosure. For the sake of brevity, FIG. 3A-3B and FIG. 3C are explained together.

In one embodiment, the interface 302A of the user device 104 may facilitate a catalog 304 containing a variety of household items available for selection, each represented by an image, description, or identification code. The catalog 304 may feature items such as bedding and linens, tableware, kitchen utensils, and decor. The user 102 may browse through the catalog 304, searching for specific items by category, material, or dimensions. The interface 302A may include interactive options, such as checkboxes, drag-and-drop features, or touch-based controls, enabling the user 102 to select one or more items easily. In another embodiment, the interface 302A may offer advanced filtering options, such as sorting items by fragility, weight, or location within the home storage space. The filtering option may allow the user 102 to make informed decisions about which items to select, especially in environments where fragile or large items are stored together. Additionally, the interface 302A may provide real-time updates on item availability, ensuring that users only select items that are currently accessible and not in use or reserved. In another embodiment, the interface 302A may provide advanced filtering options, such as sorting items by weight, dimensions, material type, or specific locations within the warehouse or storage area. The filtering may help the user 102 make informed decisions, particularly in environments where many similar items are available. In an embodiment, the interface 302A may offer real-time updates on item availability, ensuring that the user 102 is only able to select items that are currently in stock, accessible, and not reserved or in transit.

In an embodiment, the user 102 may browse the catalog 304 by scrolling through categories or searching directly using specific attributes such as material type, dimensions, or weight. For example, as shown in the interface 302A, the user 102 may select household items such as a pillow, ceramic plate, metal frame, glass vase, and a large mirror. Once selected, the item names may appear in a separate list or section, as shown by the interface 302B, showing the user 102 current selection and allowing for review before finalizing the list.

In an embodiment, the interface 302C may provide additional contextual information. For example, upon selection of the household items, the interface 302C might display the selected items current location within the shifting location 116, estimated time to shift, or specific handling instructions based on the fragility or size of the items. In an embodiment, the interface 302C may display a detailed simulation of the shifting order, providing an intricate visual representation of the two or more robotic arms 110 sequential movements as they pick up and place the selected items. The interface 302C may show a dynamic and interactive view where the user 102 may observe each of the two or more robotic arms 110 trajectory, including approach, grasping, and placement actions. The simulation may visualize the complete workflow, detailing how items may be moved from initial locations to intended destinations. The simulation may include annotations or highlights to indicate key stages in the process, such as item retrieval, transit, and placement.

In an embodiment, the interface 302C may present the shifting order of the selected household items based on features and attributes. For instance, based on the user 102 selection of a pillow, ceramic plate, dutch oven, glass vase, and a large mirror, the system 108 may determine and execute the shifting process. The system 108 may identify the robotic arms 110 suitable for handling the delicate glass vase. Further, the system 108 may employ robotic arms equipped with a gentle grip and slower movement to ensure the vase is carefully shifted to the designated location without risk of damage. Following the handling of the vase, the system 108 may address the ceramic plate, which also requires careful handling to avoid chipping or breaking. Subsequently, the system 108 may manage the lightweight pillow, which requires a different approach due to soft and pliable nature of the pillow. The two or more robotic arms 110 may use a different gripping mechanism or suction device to pick up the pillow and transfer it to the drop-off location. After handling the pillow, the system 108 may shift the sturdy dutch oven, applying more force to lift the oven safely and position it with precision. In the final step, the system 108 may handle the large mirror, which is both heavy and fragile. The selected two or more robotic arms 110 may apply a firm but gentle grip to pick up the mirror and place it securely in its new location, ensuring its safe transfer without risking damage to the mirror or surrounding objects.

In an embodiment, the simulation on the interface 302C may offer a detailed breakdown of the actions performed by the two or more robotic arms 110, including timestamps or progress indicators. The simulation may allow the user 102 to monitor the duration and efficiency of each step in the process, providing insight into how quickly the items are being moved and whether the system is meeting operational targets for speed, accuracy, and safety.

In an embodiment, the interface 302C may offer interactive controls that enable the user 102 to engage directly with the simulation. The user 102 may approve the shifting order displayed by selecting the option “approve shifting order” as shown by 306, confirming that the sequence meets all criteria for optimal performance and safe handling. Alternatively, if the user 102 identifies any discrepancies or areas that require adjustment or modification, the user 102 may select the option “modify shifting order” as shown by 308. The adjustment or modification may allow for changes in the order of operations, alterations to the movement paths of the robotic arms, or recalibration of timing to suit specific needs or constraints within the environment.

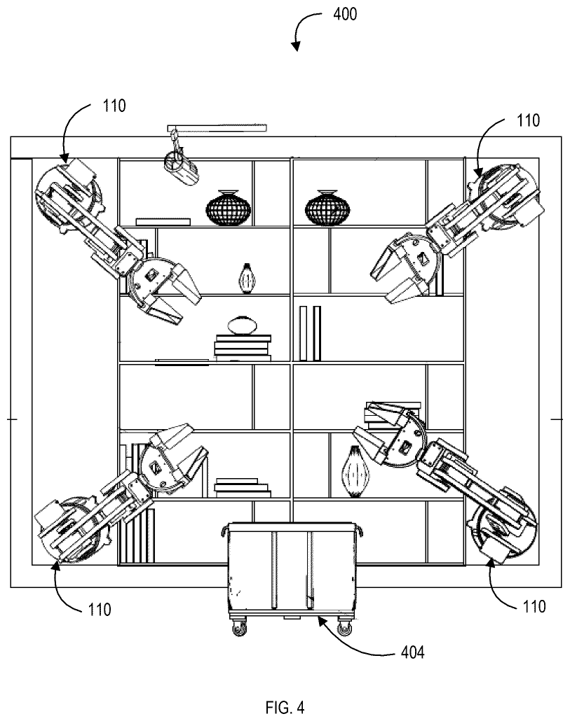

FIG. 4 illustrates an operation 400 for orchestrating two or more robotic arms 110 to manage item-shifting, in accordance with an embodiment of the present disclosure. In an embodiment, the operation 400 may include a rack 402, two or more robotic arms 110, and a dropping place 404. The two or more robotic arms 110 may be mounted in different mounting positions, such as side-mounted, bottom-mounted, or roof-mounted. The rack 402 may hold a variety of items, such as books, vases, lamps, and pots. Upon receiving the user input to shift one or more items from the rack 402, the system 108 may orchestrate the robotic arms 110 to perform the necessary actions efficiently and accurately.

In an embodiment, the system 108 may first analyze the input data to determine the optimal sequence for shifting the selected items from the rack 402. For example, if the user 102 selects a vase and a book from the shelf, the system 108 may evaluate factors such as the fragility of the vase and the ease of access to the book. Further, the system 108 may then orchestrate the two or more robotic arms 110 to first secure the vase with a gentle grip and place it carefully at the dropping place 404 before retrieving the book. In an embodiment, the robotic arms 110 may be equipped with specialized end-effectors tailored to the specific items they are handling. For example, two or more robotic arms 110 having soft gripper may be used to gently lift and transport vases, ensuring they are not damaged during the shifting process. Two or more robotic arms 110 with end effectors having firmer grip may be utilized to securely handle books, providing the necessary support to prevent them from slipping or falling during movement. Additionally, the robotic arms 110 may be designed to adapt the grip strength and movement speed based on the type of item being handled, further enhancing the precision and safety of the shifting operation.

In an embodiment, the orchestration system 108 may utilize sensor data from the one or more sensors 112 to dynamically adjust the two or more robotic arms actions. For instance, if the system 108 detects that the vase is exceptionally fragile, it may instruct the robotic arms 110 to apply a more delicate grip and reduce the speed of movement to minimize the risk of breakage. Similarly, the system 108 may prioritize the shifting order based on the size and weight of the items, ensuring that heavier items like pots are moved in a way that does not disturb the more delicate items such as vases or lamps.

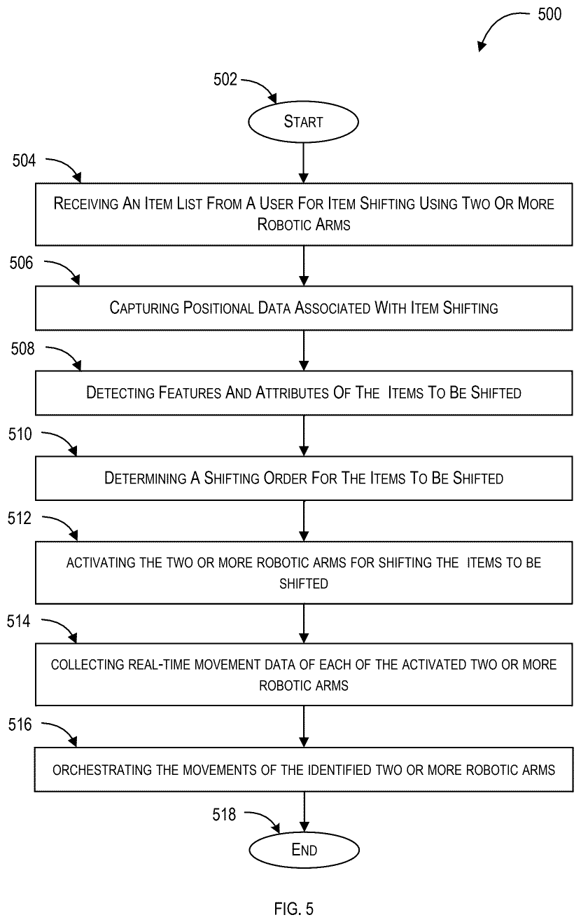

FIG. 5 illustrates a flowchart 500 of a method for orchestrating two or more robotic arms 110 to manage item-shifting, in accordance with an embodiment of the present disclosure. The method starts at step 502.

At first, an item list from a user for item shifting using two or more robotic arms may be received via a communication device at step 504. The item list may include one or more items selected from a plurality of available items. The items shifting includes picking the selected one or more items and/or dropping the selected one or more items. In an embodiment, the two or more robotic arms may include an end actuator on each of the two or more robotic arms for shifting one or more items. The end actuator on each robotic arm may include a gripper or a suction mechanism for item handling. In an embodiment, the two or more robotic arms may be of a mounting type.

Next at step 506, positional data associated with item shifting may be captured. The positional data may include layout of a shifting location, position of the selected one or more items to be shifted, and/or location of each of the two or more robotic arms. The shifting location includes at least one of: a pick-up location and a drop-off location.

Next at step 508, features and attributes of the selected one or more items to be shifted may be detected. The detected features and attributes of the one or more items may include identification, size, shape, and softness of the selected one or more items.

Next at step 510, a shifting order for the selected one or more items to be shifted may be determined. The shifting order may be determined based on the captured layout of the shifting location, the captured position of the one or more items to be shifted, the captured position of the two or more robotic arms, and/or the detected features and attributes of the selected one or more items to be shifted. In an embodiment, the capturing positional data features, detecting features and attributes, and determination of plurality of available items is performed by one or more sensors. The one or more sensors includes at least one of: visual capturing sensor, product identification code recognition sensor, RGB cameras, lidar, and stereo vision cameras.

Next at step 512, the two or more robotic arms for shifting the selected one or more items to be shifted may be activated. The two or more robotic arms may be activated based on the shifting order, and power consumption of each of the two or more robotic arms.

Next at step 514, real-time movement data of each of the activated two or more robotic arms may be collected. The collected data may include information on the robotic arms positions, speeds, and operational status. The collected movement data may be analyzed to optimize future operations, enhancing the overall efficiency and accuracy of the item-shifting process.

Next at step 516, the movements of the identified two or more robotic arms may be orchestrated. The orchestrating of the two or more robotic arms may be based on the shifting order, the activated two or more robotic arms, and/or the collected real-time movement data. In an embodiment, the method may include rendering a simulation depicting the shifting order, the identified two or more robotic arms, and an estimated time required to shift the one or more items from the item list. Further, the method may include obtaining user approval to orchestrate the movements of the identified two or more robotic arms. The method end at step 518.

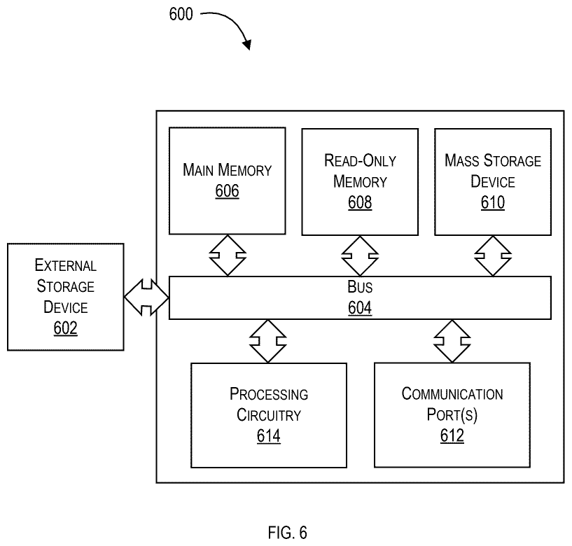

FIG. 6 illustrates an exemplary computer system in which or with which embodiments of the present disclosure may be utilized. As shown in FIG. 6, a computer system 600 includes an external storage device 614, a bus 612, a main memory 606, a read-only memory 608, a mass storage device 610, a communication port 604, and a processor 602.

Those skilled in the art will appreciate that computer system 600 may include more than one processor 602 and communication ports 604. Examples of processor 602 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 602 may include various modules associated with embodiments of the present disclosure.

The communication port 604 can be any of an RS-232 port for use with a modem-based dialup connection, a 10/100 Ethernet port, a Gigabit or 10 Gigabit port using copper or fiber, a serial port, a parallel port, or other existing or future ports. The communication port 604 may be chosen depending on a network, such as a Local Area Network (LAN), Wide Area Network (WAN), or any network to which the computer system connects.

The memory 606 can be Random Access Memory (RAM), or any other dynamic storage device commonly known in the art. Read-Only Memory 606 can be any static storage device(s) e.g., but not limited to, a Programmable Read-Only Memory (PROM) chips for storing static information e.g. start-up or BIOS instructions for processor 602.

The mass storage 610 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 612 communicatively couples processor(s) 602 with the other memory, storage, and communication blocks. The bus 612 can be, e.g. a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 602 to a software system.

Optionally, operator and administrative interfaces, e.g. a display, keyboard, and a cursor control device, may also be coupled to bus 612 to support direct operator interaction with the computer system. Other operator and administrative interfaces can be provided through network connections connected through communication port 604. An external storage device 610 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system and method (together referred to as the “mechanism”) for orchestrating two or more robotic arms provides a significant advancement in automated item management. The mechanism ensures precise and efficient handling of a wide variety of items by seamlessly coordinating the movements of the robotic arms, thereby enhancing the overall efficiency of item-shifting operations in environments such as warehouses, manufacturing plants, and retail stores. Traditional systems often face challenges with synchronization, requiring complex programming and manual oversight to manage the simultaneous operation of multiple robotic arms. In contrast, the disclosed mechanism provides an intelligent orchestration of the two or more robotic arms, enabling smooth, accurate, and fully automated item shifting without the need for manual intervention.

The disclosed mechanism is designed to handle items with diverse characteristics, including variations in size, weight, shape, and fragility. By dynamically adjusting to the specific requirements of each item, the mechanism ensures that delicate objects, such as glassware or electronics, are handled with gentle precision to minimize the risk of damage. The mechanism automatically calibrates the force applied by the robotic arms, allowing them to gently grip fragile items while exerting greater strength and stability for heavier or bulkier objects. The adaptive capability enables the two or more robotic arms to effectively manage a wide range of items in a single operation, significantly improving both speed and safety.

Overall, the disclosed mechanism optimizes the item-shifting process by ensuring that the two or more robotic arms are perfectly synchronized, delivering coordinated, accurate, and careful handling of items at every stage of the shifting process. The mechanism may manage multiple robotic arms in a flexible, responsive, and autonomous manner to handle high volumes of goods with varied handling requirements.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

I/We claim:

1. A system for orchestrating robotic arms to manage item shifting, the system comprising:
a receiver to receive, via a communication device, an item list from a user for item shifting using two or more robotic arms, wherein the item list includes one or more items selected from a plurality of available items;
a mapping module to capture positional data associated with item shifting wherein the positional data includes at least one of: layout of a shifting location, position of the selected one or more items to be shifted, and location of each of the two or more robotic arms;
a detection module to detect features and attributes of the selected one or more items to be shifted; and
a centralized control unit configured to:
determine a shifting order for the selected one or more items to be shifted, based on at least one of: the captured layout of the shifting location, the captured position of the one or more items to be shifted, the captured position of the two or more robotic arms, and the detected features and attributes of the selected one or more items to be shifted;
activate the two or more robotic arms for shifting the selected one or more items to be shifted, based on at least one of: the shifting order, and power consumption of each of the two or more robotic arms;
collect real-time movement data of each of the activated two or more robotic arms; and
orchestrate the movements of the identified two or more robotic arms based on at least one of: the shifting order, the activated two or more robotic arms, and the collected real-time movement data.

2. The system of claim 1, wherein the two or more robotic arms include an end actuator on each of the two or more robotic arms for shifting one or more items.

3. The system of claim 1, wherein the system further comprises a renderer to render a simulation depicting at least one of: the shifting order, the identified two or more robotic arms, and an estimated time required to shift the one or more items from the item list.

4. The system of claim 3, wherein the centralized control unit is further configured to obtain user approval to orchestrate the movements of the identified two or more robotic arms.

5. The system of claim 1, wherein the capturing positional data features, detect features and attributes, and determination of plurality of available items is performed by one or more sensors.

6. The system of claim 1, wherein the detected features and attributes of the one or more items include at least one of: identification, size, shape, and softness of the selected one or more items.

7. The system of claim 2, wherein the end actuator on each of the two or more robotic arm includes at least one of: a gripper or a suction mechanism for item shifting.

8. The system of claim 1, wherein the two or more robotic arms are of a mounting type.

9. The system of claim 1, wherein the one or more sensors includes at least one of: visual capturing sensor, product identification code recognition sensor, RGB cameras, lidar, and stereo vision cameras.

10. The system of claim 1,
wherein the item shifting includes at least one of: picking the selected one or more items and dropping the selected one or more items; and
wherein the shifting location includes at least one of: a pick-up location and a drop-off location.

11. A method for orchestrating two or more robotic arms to manage item-shifting, the method comprising:
receiving, via a communication device, an item list from a user for item shifting using two or more robotic arms, wherein the item list includes one or more items selected from a plurality of available items;
capturing positional data associated with item shifting wherein the positional data includes at least one of: layout of a shifting location, position of the selected one or more items to be shifted, and location of each of the two or more robotic arms;
detecting features and attributes of the selected one or more items to be shifted;
determining a shifting order for the selected one or more items to be shifted, based on at least one of: the captured layout of the shifting location, the captured position of the one or more items to be shifted, the captured position of the two or more robotic arms, and the detected features and attributes of the selected one or more items to be shifted;
activating the two or more robotic arms for shifting the selected one or more items to be shifted, based on at least one of: the shifting order, and power consumption of each of the two or more robotic arms;
collecting real-time movement data of each of the activated two or more robotic arms; and
orchestrating the movements of the identified two or more robotic arms based on at least one of: the shifting order, the activated two or more robotic arms, and the collected real-time movement data.

12. The method of claim 11, wherein the two or more robotic arms include an end actuator on each of the two or more robotic arms for shifting one or more items.

13. The method of claim 11, wherein the method further comprises rendering a simulation depicting at least one of: the shifting order, the identified two or more robotic arms, and an estimated time required to shift the one or more items from the item list.

14. The method of claim 11, wherein the method further includes obtaining user approval to orchestrate the movements of the identified two or more robotic arms.

15. The method of claim 11, wherein the capturing positional data features, detection of features and attributes, and determination of plurality of available items is performed by one or more sensors.

16. The method of claim 11, wherein the detected features and attributes of the one or more items include at least one of: identification, size, shape, and softness of the selected one or more items.

17. The method of claim 12, wherein the end actuator on each robotic arm includes at least one of: a gripper or a suction mechanism for item handling.

18. The method of claim 11, wherein the two or more robotic arms are of a mounting type.

19. The method of claim 11, wherein the one or more sensors includes at least one of: visual capturing sensor, product identification code recognition sensor, RGB cameras, lidar, and stereo vision cameras.

20. The method of claim 11,
wherein the items shifting includes at least one of: picking the selected one or more items and dropping the selected one or more items; and
wherein the shifting location includes at least one of: a pick-up location and a drop-off location.
